(19) United States
(12) Patent Application Publication
(10) Pub. No.: US 2013/0039476 A1
(43) Pub. Date: Feb. 14, 2013

(54) X-RAY OPTICAL SYSTEM

(71) Applicants: Hirokatsu Miyata, Hadano-shi (JP); Kohei Okamoto, Yokohama-shi (JP)

(72) Inventors: Hirokatsu Miyata, Hadano-shi (JP); Kohei Okamoto, Yokohama-shi (JP)

(73) Assignee: CANON KABUSHIKI KAISHA, Tokyo (JP)

(21) Appl. No.: 13/568,765

(22) Filed: Aug. 7, 2012

(30) Foreign Application Priority Data
Aug. 9, 2011 (JP) 2011-173938

(51) Int. Cl. G21K 1/00

(52) U.S. Cl. 378/145

(57) ABSTRACT

An X-ray optical system includes a waveguide that includes a core and a cladding and that guides X-rays from an X-ray source, and an optical element that condenses the X-rays from the waveguide. The core has a periodic structure. The critical angle for total internal reflection of the X-rays at the interface between the core and the cladding is larger than the Bragg angle of the periodic structure. The optical element condenses the X-rays from the waveguide at least in the direction parallel to the interface between the core and the cladding.

### BACKGROUND OF THE INVENTION

1. Field of the Invention

The present invention relates to an X-ray optical system.

2. Description of the Related Art

For electromagnetic waves with a short wavelength of several tens of nanometers or less, the difference in refractive index for the electromagnetic waves between different substances is very small at 10⁻⁵ or less, and the reflectivity for an incident angle that is larger than the critical angle for total internal reflection, which is significantly small, is very low. Therefore, X-ray optical systems use optical elements that are different from those for visible light. Examples of the optical elements include a total-reflection mirror that utilizes total internal reflection at a low angle, an X-ray waveguide that utilizes total internal reflection, a diffraction grating and a multilayer film mirror that utilize diffraction due to the periodic structure of a crystal or a multilayer film, and a Fresnel zone plate. In recent years, with the goal of achieving reduced size and enhanced performance of X-ray optical systems, there have been proposed X-ray optical systems which use an X-ray waveguide that propagates electromagnetic waves confined within a thin film or a multilayer film. For example, there are proposed a flat-plate thin-film waveguide in which a thin film of a material with a low electron density is sandwiched in a material with a high electron density (Phys. Rev. Lett. 100, 184801 (2008) [4 pages] High-Transmission Planar X-Ray Waveguides T. Salditt, S. P. Kruger, C. Fuhse, and C. Bahtz), and an X-ray waveguide in which a plurality of flat-plate X-ray waveguides that confine X-rays through total internal reflection are disposed adjacent to each other (X-ray waveguides with multiple guiding layers F. Pfeiffer, T. Salditt, P. Hoghoj, I. Anderson, and N. Schell pp. 16939-16943 Physical Review B, Volume 62, Number 24, p. 16939 (2000-II)). There are also proposed optical technologies for condensing X-rays emitted from such X-ray waveguides. For example, there are proposed an optical component in which an X-ray shielding portion serving as a zone plate is provided in a waveguide (Japanese Patent Application Laid-Open No. 2008-281421), and an optical component in which a stacked Fresnel zone plate is provided behind a waveguide (Japanese Patent Application Laid-Open No. 2009-47430).

However, the technologies according to the related art are faced with several issues. In the technologies according to the non-patent and patent documents cited above, a narrow air gap of about less than 20 nm or a thin film of a material made of a light element is used as a core portion for propagation of X-rays provided in a waveguide used in an X-ray condenser optical system. Therefore, the intensity of the X-rays emitted from the waveguide is restricted to a low level by the size of the X-ray propagation portion. In addition, a cladding that confines the X-rays within the core is made of a substance with a high electron density, which results in a high loss in propagation of the X-rays at an interface. Further, the waveguide may be subjected to oxidation degradation because the material used for the cladding is selected from a limited number of materials, most of which are easily oxidized.

### SUMMARY OF THE INVENTION

The present invention provides an X-ray optical system with a simple configuration that can condense X-rays with a matching phase.

The present invention provides an X-ray optical system including a waveguide that includes a core and a cladding and that guides X-rays from an X-ray source, and an optical element that condenses the X-rays from the waveguide. The core has a periodic structure. The critical angle for total internal reflection of the X-rays at the interface between the core and the cladding is larger than the Bragg angle due to the periodic structure. The optical element condenses the X-rays from the waveguide at least in the direction parallel to the interface between the core and the cladding.

Further features of the present invention will become apparent from the following description of exemplary embodiments with reference to the attached drawings.

### BRIEF DESCRIPTION OF THE DRAWINGS

FIG. 1 is a schematic diagram illustrating the structure of an X-ray waveguide used in an X-ray condenser optical system according to the present invention.

FIG. 2A to 2C are each a schematic diagram illustrating the structure of a core having a periodic structure of the X-ray waveguide used in the X-ray condenser optical system according to the present invention.

FIGS. 3A to 3C are each a schematic diagram illustrating conditions required for the structural period of the core having a periodic structure of the X-ray waveguide used in the X-ray condenser optical system according to the present invention.

FIG. 4 is a schematic diagram illustrating incidence of X-rays into the X-ray waveguide used in the present invention and X-rays emitted from the waveguide.

FIG. 5 is a schematic diagram illustrating an X-ray condenser optical system according to the present invention formed by an X-ray waveguide and an X-ray optical element having an X-ray condensing capability.

FIG. 6 is a schematic diagram illustrating an X-ray condenser optical system formed by an X-ray waveguide and a one-dimensional Fresnel zone plate according to Example 1 of the present invention.

FIG. 7 is a schematic diagram illustrating an X-ray condenser optical system formed by an X-ray waveguide and a curved multilayer film mirror according to Example 2 of the present invention.

FIG. 8 is a schematic diagram illustrating a condenser optical system formed by two X-ray waveguides according to Example 4 of the present invention.

FIGS. 9A and 9B are each a schematic diagram illustrating the structural periodicity of a silica mesostructured film used as a core of an X-ray waveguide according to Example 5 of the present invention.

### DESCRIPTION OF THE EMBODIMENTS

A preferred embodiment of the present invention will be described in detail below with reference to the accompanying drawings.

In the present invention, X-rays refer to electromagnetic waves in a wavelength band in which the real part of the refractive index of a substance is equal to or less than 1. Specifically, X-rays refer to electromagnetic waves with a wavelength of 100 nm or less including extreme ultraviolet (EUV) light. The frequency of electromagnetic waves with such a short wavelength is very high, and thus cannot be responded to by electrons in the outermost shell of a substance. Therefore, as known, the real part of the refractive index of a substance for X-rays is less than 1 unlike the frequency band of electromagnetic waves with a wavelength equal to or more than that of ultra violetlight (such as visible light and infrared light). The refractive index n of a substance for such X-rays is generally represented by the following formula:

n=1−δ−i\tilde{β}=ñ−i\tilde{β} [Math. 1]

where δ is the amount of deviation of the real part from 1, and

\tilde{β} [Math. 2]

is the imaginary part related to absorption. Because δ is proportional to the electron density ρₑ of a substance, a substance with a higher electron density has a smaller real part of the refractive index. In addition, the real part of the refractive index is represented by:

ñ=1−δ [Math. 3]

Further, ρₑ is proportional to the atomic density ρₐ and the atomic number Z. Thus, the refractive index of a substance for X-rays is represented by a complex number. The real part and the imaginary part of the refractive index are referred to herein as “refractive index real part” or “real part of refractive index” and “refractive index imaginary part” or “imaginary part of refractive index, respectively.

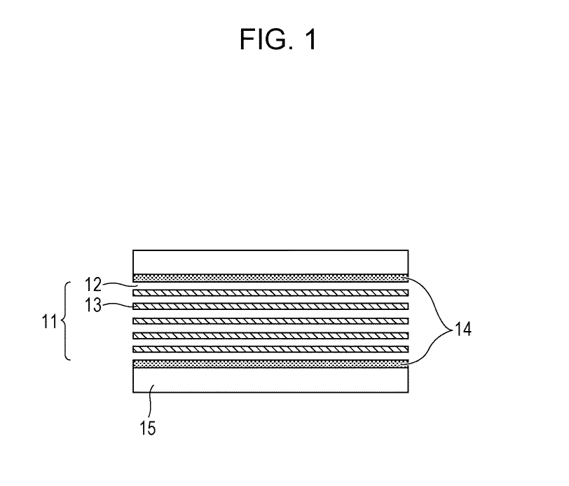

Next, an X-ray waveguide used in the embodiment will be described. As schematically shown in FIG. 1, the X-ray waveguide according to the embodiment includes a core portion 11 that guides X-rays in a wavelength band in which the real part of the refractive index of a substance is equal to or less than 1, and a cladding portion 14 that confines the X-rays within the core through total internal reflection at the interface with the core. The core portion 11 has a periodic structure in which a plurality of members (portions) 12 and 13 with refractive indices with different real parts are arranged periodically. The critical angle for total internal reflection of X-rays at the interface between the core portion 11 and the cladding portion 14 is larger than the Bragg angle due to the structural period of the core portion 11. A member 15 may be provided on the outer side of the cladding portion 14 for the purpose of improving mechanical strength. In the band of X-rays, the substance with the maximum real part of the refractive index, which is 1, is vacuum. Gases represented by air have substantially the same refractive index as that of vacuum. However, substantially all the substances but gases have a real part of the refractive index of less than 1. The refractive index of a substance for X-rays depends on the density of electrons in the substance. Therefore, in many cases, the plurality of members with refractive indices with different real parts discussed earlier may also be mentioned as a plurality of members with different electron densities.

The X-ray waveguide used in the present invention utilizes a peculiar X-ray guiding phenomenon discovered by the inventors that X-rays subjected to multiple interference due to the periodic structure of the member forming the core are guided in the core at a low propagation loss. This peculiar waveguide mode for X-rays is formed by the structural periodicity, and the positions of antinodes and nodes in the electric field distribution and the electric field intensity distribution of X-rays coincide with positions in regions of the respective substances forming the basic structure. In this case, the propagation loss of a waveguide mode in which the electric field intensity of X-rays concentrates on a substance with a low electron density of the periodic structure is lower than those of other waveguide modes, which allows the waveguide mode to be selectively taken out. Hereinafter, the waveguide mode will be referred to as “periodic resonant waveguide mode”. In order to form the X-ray waveguide used in the present invention, which enables the periodic resonant waveguide mode, it is necessary that several conditions should be met. Such conditions will be described in detail below.

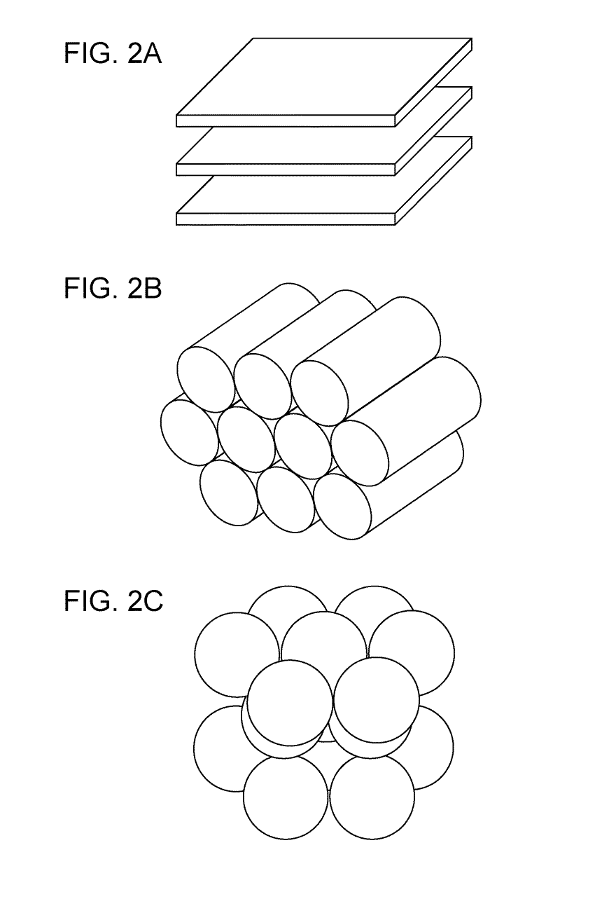

First, the core portion having a structure in which a plurality of members with refractive indices with different real parts form a periodic structure will be described. The plurality of members include any combination of members that can define a stable periodic structure, and the members are defined to include vacuum and air. That is, a material in which materials and air gaps are provided alternately to form a periodic structure is also included in the present invention. The periodic structure may have a structural period of any dimension. That is, any of one-dimensional, two-dimensional, and three-dimensional periodic structures may be used. The one-dimensional periodic structure includes a plurality of laminar materials arranged with periodicity in the stacked direction as shown in FIG. 2A. The two-dimensional periodic structure includes structural units extended infinitely in one direction are arranged regularly two-dimensionally in cross section as shown in FIG. 2B. The structural units may be arranged in a hexagonal arrangement which is shown, a cubic arrangement, or the like. The three-dimensional periodic structure includes a structure in which spherical structural units are filled closely in a cubic arrangement or a hexagonal arrangement as shown in FIG. 2C, and a double gyroid structure formed by a plurality of components subjected to phase separation with structural regularity.

In the case where there is such a periodic structure, X-rays may be scattered at the interface between the plurality of materials to cause interference, and the scattered X-rays intensify each other to cause clear diffraction as with X-ray diffraction of a crystal. In the case where the structural period of the core portion of the waveguide used in the present invention is at a level comparable to the wavelength of X-rays (1 nanometer to several tens of nanometers), X-ray diffraction is observed even if there is no structural regularity at the atomic level in each member. In the case where there is high structural regularity, multiple interference is caused, as a result of which X-rays exhibit peculiar propagation behavior in the regular structure. As discussed earlier, the X-ray waveguide according to the present invention utilizes multiple interference of X-rays. Thus, the structural period of the core component used in the present invention is desirably in the range of 1 nanometer to several tens of nanometers. In addition, the number of layers in the periodic structure of the core component is desirably in the range of about 10 layers to 500 layers. In the case where the number of layers is too small, the transmittance of the waveguide tends to be reduced. Consequently, the thickness of the core component is desirably about 10 nanometers to 10 μm.

As the core material of the X-ray waveguide according to the embodiment, there may be used an artificial multilayer film, a mesostructured thin film having a structure in which a molecular assembly of a surface active agent and an inorganic substance are arranged regularly, or a film having a regular structure formed through microphase separation of a block copolymer. However, the material is not limited to such films as long as the material can cause multiple interference of X-rays.

The artificial multilayer film is formed by stacking a plurality of materials to a predetermined thickness through sputtering or vapor deposition. While the periodicity of the structure can be controlled freely in accordance with the time of film formation, the structure that can be formed is limited to a one-dimensional periodic structure.

The mesostructured film is an inorganic-organic composite fabricated by applying a precursor solution containing a surface active agent and an inorganic precursor onto a substrate and causing self-assembly of the surface active agent and the inorganic species on the substrate. The mesostructured film is a film having a periodic structure of about 2 to 50 nanometers. The dimension, the symmetry, and the structural period of the regular structure in the film can be varied by varying the surface active agent and the inorganic precursor substance used and their respective concentrations. In particular, a mesoporous film, which is a film of a structure in which air and an inorganic substance are three-dimensionally regularly arranged, is desirably used in the present invention. This is because the mesoporous film causes X-rays to concentrate on a cavity portion at a low loss to enable propagation of X-ray at a low loss. The mesoporous film is fabricated by removing a surface active agent from a surface active agent-inorganic material mesostructured film.

The phase-separated structure of a block copolymer is a high molecular compound in which a plurality of high molecular segments with different natures are coupled to each other through covalent bonding, and forms a regular microphase-separated structure based on the nature and the molecular weight of each component forming the structure. The symmetry of the resulting regular structure can be controlled by controlling the molecular amount of each segment. A periodic structure with a high contrast in electron density can be fabricated using a material that can be converted into an inorganic substance. The block copolymer can form a regular structure through a simple process of applying the block copolymer to a substrate and thereafter heating the block copolymer.

Next, the cladding portion will be described. As discussed earlier, the cladding serves to confine X-rays subjected to multiple interference by the periodic structure of the core within the core through total internal reflection. The critical angle for total internal reflection of X-rays for a substance is determined in accordance with the wavelength of the X-rays used and the electron density of the substance. A substance with a higher electron density has a lower refractive index, and therefore provides a larger critical angle for total internal reflection. As discussed earlier, it is necessary that the Bragg angle which corresponds to the periodic structure of the core should be smaller than the critical angle for total internal reflection. Therefore, in the case where the cladding is formed of a light element, it is necessary to reduce the Bragg angle, that is, to increase the structural period, of the core. However, increasing the structural period may lead to a reduction in structural regularity. Therefore, the cladding material is desirably formed of a substance with a high electron density. Tungsten, tantalum, gold, or bismuth is desirably used.

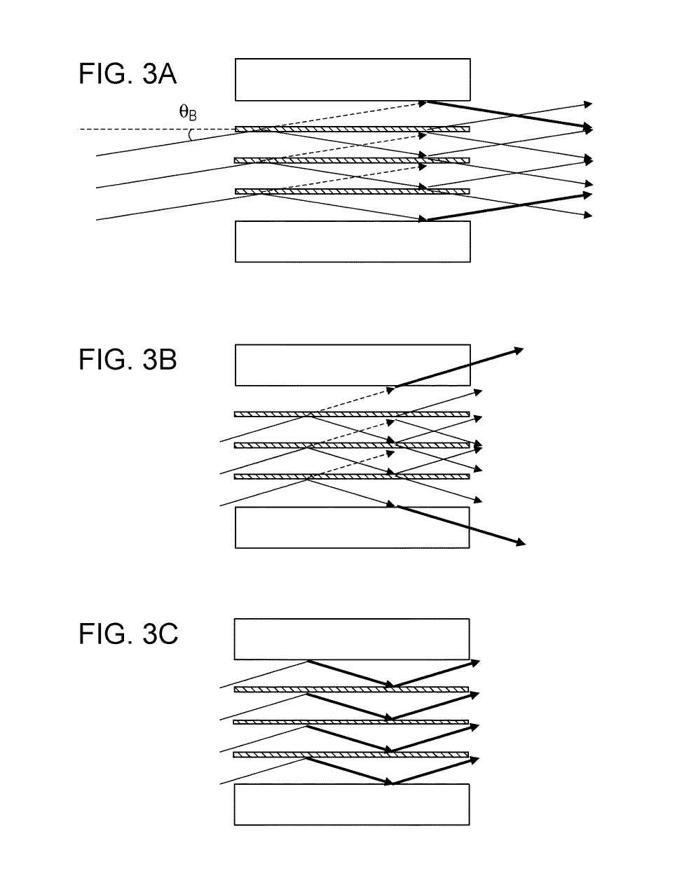

In the X-ray waveguide according to the present invention, as discussed earlier, it is necessary that X-rays should be confined within the core through total internal reflection at the core-cladding interface so that X-rays subjected to multiple interference inside the core made of a material having a periodic structure will not exit out of the core. This inevitably requires the condition that the Bragg angle which corresponds to the periodic structure of the core portion forming the waveguide is smaller than the critical angle for total internal reflection at the core-cladding interface. FIG. 3A schematically shows a configuration in which X-rays subjected to multiple interference are totally reflected at the interface with the cladding. In the case where this condition is not met, X-rays subjected to multiple interference significantly leak out of the core member into the cladding member as shown in FIG. 3B. This condition is not desirable. Consequently, the X-ray waveguide according to the present invention does not function as a waveguide any more. The condition described above can be represented using formulas as follows.

When the real part of the refractive index of a substance on the cladding side at the interface between the cladding and the core is defined as n_{clad} and the real part of the refractive index of a substance on the core side is defined as n_{core}, n_{clad}<n_{core}, the critical angle θ_{c-total}(°) for total internal reflection from the direction parallel to the film surface is represented by:

$${θ}_{c - tool} \approx \frac{180}{π} arccos ( \frac{{n}_{clad}}{{n}_{core}} ) . \qquad [ Math . 4 ]$$

In addition, when the structural period of the periodic structure forming the core is defined as d, the Bragg angle θ_{B}(°) is defined, irrespective of the presence or absence of multiple diffraction inside the core, by:

$${θ}_{B} \approx \frac{180}{π} arcsin ( m \frac{λ}{2 d} ) \qquad [ Math . 5 ]$$

where m is a constant and λ is the wavelength of X-rays. It is necessary that parameters for the physical property of substances forming the X-ray waveguide according to the present invention, the parameters for structure of the waveguide, and the wavelength of X-rays should meet the following formula:

θ_{B}<θ_{c-total}. [Math. 6]

In the present invention, another condition is desirably met. The second condition is particularly importance in the case where the periodic structure of the core is one-dimensional. The second condition will be described. In the case where the periodic structure is formed from a plurality of members with refractive indices with different real parts, it is necessary to consider reflection of X-rays at the interface between the members. In order for the X-ray waveguide used in the condenser optical system according to the present invention to function, multiple interference due to the periodic structure must be caused. In the case where total internal reflection is caused at the interface between the materials forming the periodic structure, X-rays are confined within films of a material with the highest refractive index, of the materials forming the stacked structure as shown in FIG. 3C. This hinders multiple interference to make it difficult to address the issue to be addressed by the present invention. In other words, the unit forming the periodic structure functions as a multiple total internal reflection X-ray waveguide, which has the same structure as that of the flat-plate waveguide according to the related art. This requires the condition that the critical angle for total internal reflection at the interface between members with refractive indices with different real parts forming the periodic structure of the core is smaller than the Bragg angle. This condition can be represented using a formula as follows.

When the critical angle for total internal reflection between materials with refractive indices with different real parts forming the periodic structure of the core is defined as θ_{C}_{_{—}}ₘᵤₗₜᵢ(°), the following formula is met:

θ_{C}_{_{—}}ₘᵤₗₜᵢ<θ_{B}. [Math. 7]

In the case where the conditions discussed above are met, the waveguide mode confined through total internal reflection at the interface between the cladding and the core can be caused to exist locally within the core. The effective propagation angle θ_{E} as measured from the direction parallel to the film is represented using a wave number vector (propagation constant) k_{z} in the propagation direction of the waveguide mode and a wave number vector k₀ in vacuum by the following formula:

$${θ}_{E} = \frac{180}{π} arccos ( \frac{{k}_{z}}{{k}_{0}} ) . \qquad [ Math . 8 ]$$

In the X-ray waveguide used in the present invention described above, only X-rays in the waveguide mode which resonates with the period of the regular structure through multiple interference can be selectively propagated at a low loss. The X-rays in the waveguide mode have a matching phase through the overall thickness of the core, that is, are spatially coherent, and are emitted at a small divergence angle from an end surface of the waveguide.

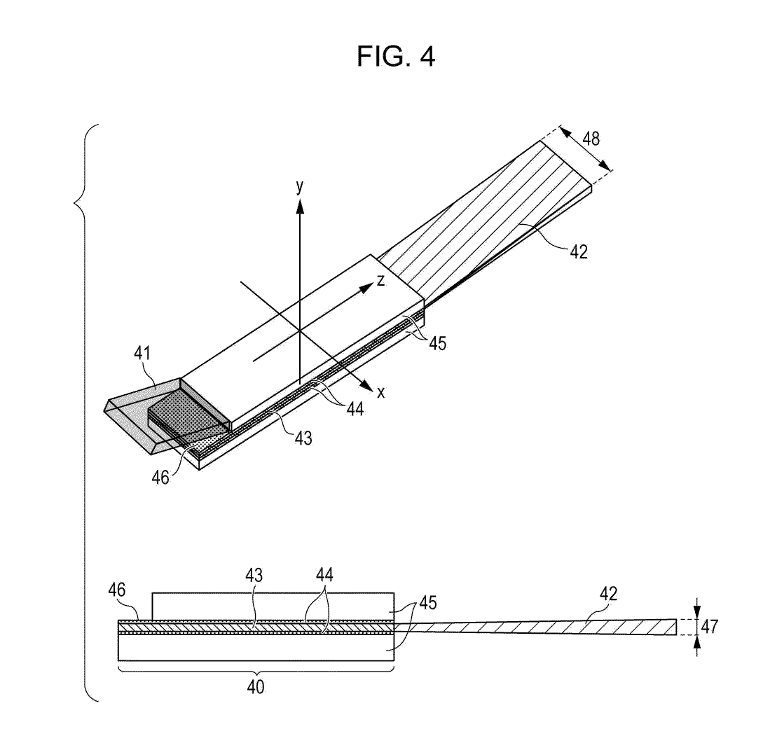

FIG. 4 is a schematic diagram illustrating X-rays incident into an X-ray waveguide 40 used in the present invention and X-rays emitted from the waveguide. In FIG. 4, reference numeral 41 denotes an X-ray beam incident from an X-ray source into the waveguide, 42 denotes an X-ray beam emitted from the waveguide, 43 denotes a core made of a material having a periodic structure, 44 denotes a cladding, 45 denotes a base material (e.g., shielding material) provided on the outer side of the cladding, and 46 denotes an upper cladding on the X-ray incident portion. In addition, reference numeral 47 denotes the beam size of the emitted X-rays in the direction perpendicular to the core-cladding interface, and 48 denotes the beam size of the emitted X-rays in the direction parallel to the core-cladding interface. In FIG. 4, X-rays are incident from the upper cladding side. However, the manner of incidence of X-rays into the X-ray waveguide according to the present invention is not limited to that shown in FIG. 4, and X-rays may be incident from the end surface of the waveguide, for example. In FIG. 4, the base materials are provided on the outer side of the cladding. However, the base materials are not essential constituent elements that affect guidance of X-rays. In FIG. 4, X-rays emitted from the X-ray waveguide are emitted from the end surface in a direction at an angle defined by parameters for the waveguide and the wavelength of the X-rays. Since the X-rays have a matching phase, the divergence angle of the X-rays in the direction of the thickness of the waveguide has a very small value of less than 0.01°. In consideration of the thickness of the core portion of the waveguide, an X-ray beam with a very small size 47 in this direction can be obtained as shown in FIG. 4. However, in the direction parallel to the core-cladding interface, the X-rays emitted from the waveguide have a width 48 defined by one of the size of the X-rays incident into the waveguide and the width of the waveguide in the direction perpendicular to the film thickness direction. Therefore, in general, the beam size is not reduced. Simply reducing the width of the waveguide decreases the absolute intensity of the resulting beam, and therefore is not effective.

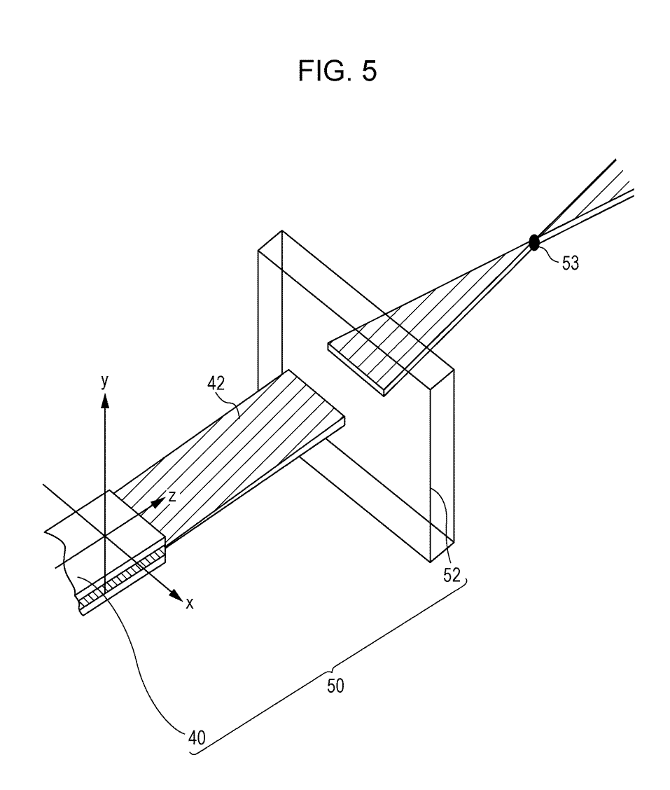

As discussed above, the condenser optical system according to the present invention is an optical system that condenses an X-ray beam emitted from an X-ray waveguide and having a matching phase and a flat shape with a very small beam size in one direction into a beam with a small beam size without reducing intensity. That is, as shown in FIG. 5, the condenser optical system according to the present invention is an X-ray optical system 50 obtained by combining the X-ray waveguide 40 discussed above and an X-ray optical element 52 that can condense in one direction the X-ray beam 42 emitted from the waveguide. The X-ray optical element 52 is an X-ray optical element that condenses X-rays in one direction, and condenses X-rays emitted from the waveguide in the direction that is parallel to the interface between the core and the cladding and that is perpendicular to the direction of emission of the X-rays from the waveguide. A one-dimensional Fresnel zone plate, a total-reflection mirror, or a multilayer film mirror may be used as the X-ray optical element 52. Two X-ray waveguides may be used in a configuration in which a second X-ray waveguide disposed behind a first X-ray waveguide is rotated by an angle of 90 degrees so as to condense the beam in the direction of the wider size. FIG. 5 schematically shows a configuration in which the optical element transmits X-rays. However, the optical element is not limited to use in a transmissive configuration, and may also be used in a reflective configuration. The X-rays emitted from the optical element 52 are condensed at a focal point 53. As a result, a very small X-ray beam with high intensity can be obtained.

The X-ray condenser optical system according to the present invention will be described in further detail below with reference to examples. However, the present invention is not limited to such examples.

### Example 1

This example relates to a condenser optical system in which X-rays emitted from an X-ray waveguide are condensed in one direction using a one-dimensional Fresnel zone plate. The X-ray waveguide was formed by sandwiching a core made of a multilayer film formed from boron carbide (B₄C) and alumina (Al₂O₃) in a tungsten cladding.

A tungsten film of 20 nm was formed on a silicon substrate, and thereafter an alternately stacked film of boron carbide (B₄C) and alumina (Al₂O₃) was formed by sputtering. The film thickness of B₄C was 12 nm, the film thickness of Al₂O₃ was 3 nm, the structural period was 15 nm, and the number of layers was 100. Al₂O₃ contacted tungsten. Tungsten of 20 nm was formed on the multilayer film by sputtering to form a waveguide. Tungsten over the portion of incidence of X-rays was etched to a film thickness of 5 nm. The length of the waveguide was 3 mm.

X-rays with an energy of 10 keV were incident into the waveguide to observe how the X-rays were guided. For X-rays with such an energy, the critical angle for total internal reflection at the Al₂O₃—W interface was 0.36°, and the Bragg angle which corresponds to the structural period, 15 nm, was 0.23°. The critical angle for total internal reflection at the interface between B₄C and Al₂O₃ was 0.14°.

When the travel direction of the X-rays is defined as z, the direction perpendicular to the core-cladding interface is defined as y, and the axis perpendicular to both the directions is defined as x as shown in FIGS. 4 and 5, the beam size of the incident X-rays was 0.15 mm in the y direction and 0.4 mm in the x direction.

In the case where the incident angle of the X-rays was varied in the y-z plane, the transmittance of the waveguide for X-rays became selectively large when the incident angle substantially coincided with the Bragg angle, and propagation of X-rays at a low loss due to the waveguide mode which resonates with the periodic structure was confirmed.

The X-rays emitted from the waveguide had a matching phase in the y direction, and hence had a very small divergence angle of 0.008° in the y direction. The cross-sectional thickness of the core in the end surface of the X-ray waveguide was 1.5 μm. Therefore, the obtained X-ray beam had a small size in the y direction. In the x direction, however, the X-ray beam had a width of 0.4 mm, which was the same as the size of the incident X-rays.

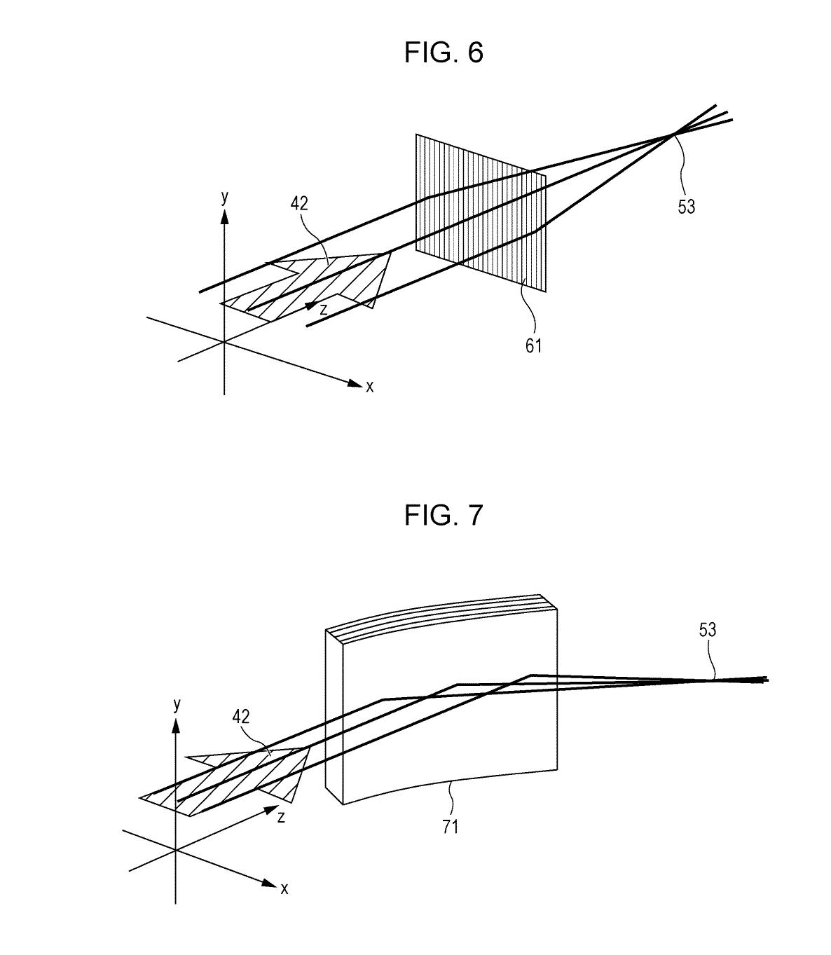

A one-dimensional Fresnel zone plate 61 designed with a focal length f of 300 mm for X-rays at 10 keV was provided behind the X-ray beam. FIG. 6 schematically shows the configuration of this example. The Fresnel zone plate had 600 linear zones for each of the left and right sides in the x direction with respect to the center of the X-ray beam. A material that shields X-rays was provided linearly between (2nλf)^{1/2} and {(2n+1)λf}^{1/2}. λ is the wavelength of X-rays, which is equal to 0.12 nm.

As shown in FIG. 6, the X-rays 42 emitted from the X-ray waveguide were incident into the Fresnel zone plate, and thereafter condensed in the x direction such that the beam size in the x direction at the focal point 53 was less than 1 μm.

The divergence angle of the beam in the y direction was small. Therefore, the beam size in the y direction was kept small at 30 μm or less even at a point 300 mm away.

With the condenser optical system according to this example, as described above, a very small X-ray beam with a matching phase was obtained with a simple configuration.

### Example 2

This example relates to a condenser optical system that condenses X-rays emitted from an X-ray waveguide configured in the same manner as that used in Example 1 using a curved multilayer film mirror. The X-ray waveguide used in this example was sized and configured in the same manner as that used in Example 1, and conditions for X-rays incident into the waveguide were also the same as those in Example 1. The energy of the X-rays used was 10 keV, which was also the same as that in Example 1.

A curved multilayer film mirror 71 used was formed by forming a multilayer film of tungsten (W) and boron carbide (B₄C) in 100 layers on a paraboloidal surface, and had a focal length of 120 mm.

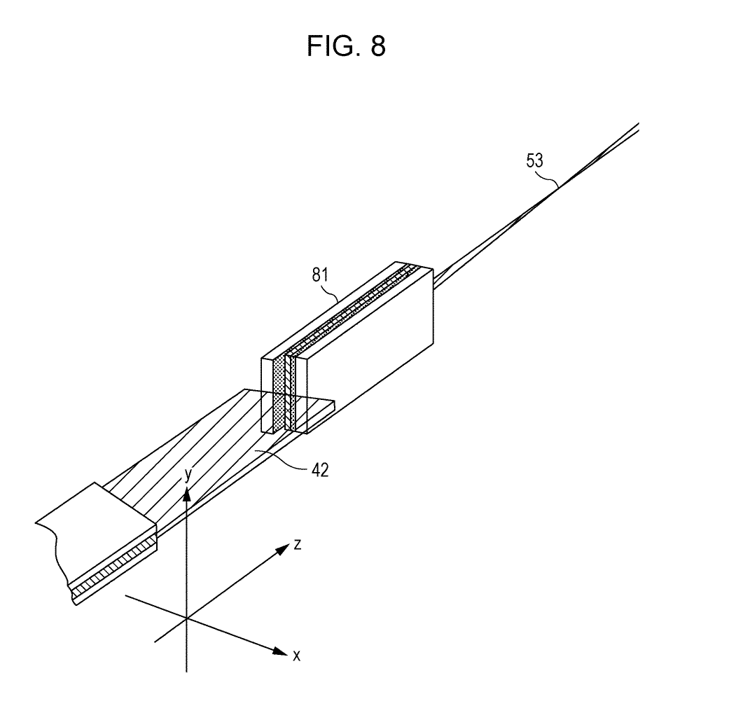

FIG. 7 schematically shows the configuration of this example. As shown in FIG. 7, the X-rays 42 emitted from the X-ray waveguide were incident into the curved multilayer film mirror, and thereafter condensed in the x direction such that the beam size in the x direction at the focal point 53 was about 5 μm.

The divergence angle of the beam in the y direction was small. Therefore, the beam size in the y direction was kept small at 15 μm or less even at a point 120 mm away.

With the condenser optical system according to this example, as described above, a very small X-ray beam with a matching phase was obtained with a simple configuration.

### Example 3

This example relates to a condenser optical system that condenses X-rays emitted from an X-ray waveguide configured in the same manner as those used in Examples 1 and 2 using an elliptical total-reflection mirror. The X-ray waveguide used in this example was sized and configured in the same manner as those used in Examples 1 and 2, and conditions for X-rays incident into the waveguide were also the same as those in Examples 1 and 2. The energy of the X-rays used was 10 keV, which was also the same as that in Examples 1 and 2.

The elliptical total-reflection mirror used was formed by shaping silica glass so as to have an elliptical surface and sputtering platinum onto the elliptical surface, and had a focal length of 70 mm.

The elliptical total-reflection mirror was disposed in the same manner as shown in FIG. 7. X-rays emitted from the X-ray waveguide were incident into the elliptical total-reflection mirror, and thereafter condensed in the x direction such that the beam size in the x direction at the focal point was about 5 μm.

The divergence angle of the beam in the y direction was small. Therefore, the beam size in the y direction was kept small at about 8 μm even at a point 70 mm away.

With the condenser optical system according to this example, as described above, a very small X-ray beam with a matching phase was obtained with a simple configuration.

### Example 4

This example relates to a condenser optical system that can form a very small beam with a matching phase fabricated by coupling two X-ray waveguides configured in the same manner as those used in Examples 1 to 3 perpendicularly to each other. The X-ray waveguide used in this example was sized and configured in the same manner as those used in Examples 1 to 3, and conditions for X-rays incident into the waveguide were also the same as those in Examples 1 to 3. The energy of the X-rays used was 10 keV, which was also the same as that in Examples 1 to 3.

The arrangement of the two X-ray waveguides in this example is shown in FIG. 8. The X-rays 42 emitted from a first waveguide had a narrow divergence angle in the direction perpendicular to the core-cladding interface of the first waveguide, but were wide in the direction parallel to the interface. A second waveguide 81 was disposed in the X-rays such that the core-cladding interface of the second waveguide was orthogonal to the core-cladding interface of the first waveguide as shown in FIG. 8. The distance between the first waveguide and the second waveguide was 10 mm.

The size of the X-ray beam obtained from the thus configured X-ray condenser optical system was kept small at about 5 μm in both the x direction and the y direction at a point 50 mm away from the exit of the second waveguide.

With the condenser optical system according to this example, as described above, a very small X-ray beam with a matching phase was obtained with a simple configuration.

### Example 5

This example uses an X-ray waveguide in which a mesoporous silica film is used as a core and sandwiched in a tungsten cladding. The mesoporous silica film is a material formed by self-assembly of a surface active agent and having nanoscale structural regularity. That is, in this example, a plurality of members forming the core are a silica portion and a hole portion of the mesoporous silica film. In this example, in addition, X-rays emitted from the waveguide are condensed using a one-dimensional Fresnel zone plate that is the same as that used in Example 1.

A film of tungsten with a film thickness of 15 nm was formed on a silicon substrate by sputtering, and a silica mesostructured film having a two-dimensional hexagonal structure was formed on the tungsten film in accordance with the following procedures.

An ethanol solution of a block polymer was added to a solution prepared by mixing ethanol, 0.01 M of hydrochloric acid, and tetraethoxysilane for 20 minutes. The mixture was agitated for 3 hours to prepare a precursor solution. Ethylene oxide (20)-propylene oxide (70)-ethylene oxide (20) (hereinafter referred to as “EO(20)-PO(70)-EO(20)”) was used as the block polymer (the numbers in the parentheses indicate the number of repetitions of each block). In this example, ethanol was used as a solvent. However, methanol, propanol, 1,4-dioxane, tetrahydrofuran, or acetonitrile may also be used in place of ethanol. The composition ratio (molar ratio) of each component in the precursor solution was 1.0 for tetraethoxysilane, 0.0011 for hydrochloric acid, 5.2 for ethanol, 0.0096 for block polymer, and 3.5 for ethanol. The film thickness can be adjusted by adding the solvent to the precursor solution to vary viscosity. In this case, other parameters such as agitation time may be optimized as appropriate.

The precursor solution was applied to the substrate on which tungsten had been formed using a dip coating device at a pulling speed of 0.5 to 2 mms⁻¹. The temperature and the relative humidity of the environment for dip coating were 25° C. and 40%, respectively. After formation of a film, the film was held for 24 hours in a thermostat/humidistat bath at a temperature of 25° C. and a relative humidity of 50%.

After this process, the film on the substrate was exposed to chlorotrimethoxysilane vapor at 80° C. for 12 hours, and thereafter immersed in ethanol to extract a surface active agent in pores for removal, obtaining a mesoporous silica film having hollow pores. Infrared absorption spectroscopy was used to confirm if the surface active agent had been removed. The mesoporous silica film was evaluated through Bragg-Brentano X-ray diffraction analysis. The mesostructured film was confirmed to have high orderliness in the direction normal to the substrate surface and have an interplanar spacing, that is, a period in the confinement direction, of 10.2 nm. The film thickness was approximately 400 nanometers.

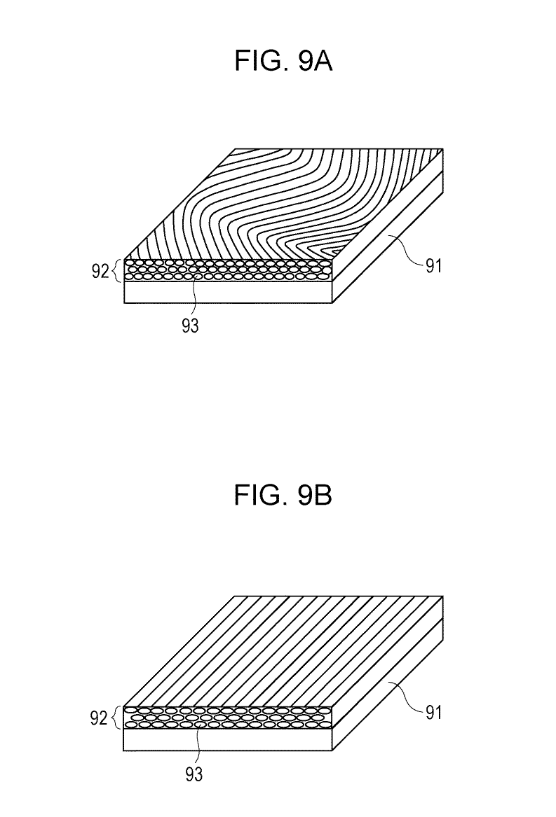

The thus formed mesostructured film is schematically shown in FIGS. 9A and 9B. As shown, tubular pores 93 are arranged regularly over the entire mesostructured film 92, forming a periodic structure in the direction perpendicular to a substrate 91. In the mesostructured film used in this example, the in-plane orientation of the pores is not controlled as shown in FIG. 9A. However, since the mesostructured film has regularity in the film thickness direction, the mesostructured film can be suitably used in the present invention. As a matter of course, the in-plane orientation of the pores may be controlled as shown in FIG. 9B.

A film of tungsten, which is the material of the upper cladding, with a film thickness of 15 nm was formed on the mesoporous silica film by sputtering to form an X-ray waveguide. As in Examples 1 to 4, tungsten over the portion of incidence of X-rays was etched to a film thickness of 5 nm. The length of the waveguide was 3 mm.

X-rays with an energy of 10 keV were incident into the waveguide to observe how the X-rays were guided. For X-rays with such an energy, the critical angle for total internal reflection at the SiO₂—W interface was 0.40°, and the Bragg angle which corresponds to the structural period, 10.2 nm, was 0.34°. The critical angle for total internal reflection at the SiO₂-air interface was 0.16°.

When the travel direction of the X-rays is defined as z, the direction perpendicular to the core-cladding interface is defined as y, and the axis perpendicular to both the directions is defined as x as in FIGS. 4 and 5, the beam size of the incident X-rays was 0.15 mm in the y direction and 0.4 mm in the x direction.

In the case where the incident angle of the X-rays was varied in the y-z plane, the transmittance of the waveguide for X-rays became selectively large when the incident angle substantially coincided with the Bragg angle, and propagation of X-rays at a low loss due to the waveguide mode which resonates with the periodic structure was confirmed.

The X-rays emitted from the waveguide had a matching phase in the y direction, and hence had a very small divergence angle of 0.008° in the y direction. The cross-sectional thickness of the core in the end surface of the X-ray waveguide used in this example was 0.4 μm. Therefore, the obtained X-ray beam had a small size in the y direction. In the x direction, however, the X-ray beam had a width of 0.4 mm, which was the same as the size of the incident X-rays.

A one-dimensional Fresnel zone plate designed with a focal length f of 300 mm for X-rays at 10 keV, which is the same as that used in Example 1, was provided behind the X-ray beam. The Fresnel zone plate had 600 linear zones for each of the left and right sides in the x direction with respect to the center of the X-ray beam. A material that shields X-rays was provided linearly between (2nλf)^{1/2} and {(2n+1)λf}^{1/2}. λ is the wavelength of X-rays, which is equal to 0.12 nm.

In this example, X-rays emitted from the X-ray waveguide were incident into the Fresnel zone plate, and thereafter condensed in the x direction such that the beam size in the x direction at the focal point was less than 1 μm.

The divergence angle of the beam in the y direction was small. Therefore, the beam size in the y direction was kept small at 8 μm or less even at a point 300 mm away.

With the condenser optical system according to this example, as described above, a very small X-ray beam with a matching phase was obtained with a simple configuration.

While a preferred embodiment of the present invention has been described above, the present invention is not limited thereto, and various modifications and alterations may be made without departing from the scope and spirit of the present invention.

The technical elements described herein or illustrated in the drawings demonstrate their technical usefulness singly or in various combinations, and should not be limited to the combinations claimed at the time of filing. The technology illustrated herein or in the drawings addresses a plurality of issues, and has technical usefulness by addressing just one of such issues.

The X-ray condenser optical system according to the present invention may be utilized as a general X-ray optical system in the field of X-ray optical technologies such as X-ray photography and X-ray exposure.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2011-173938 filed Aug. 9, 2011, which is hereby incorporated by reference herein in its entirety.

What is claimed is:

1. An X-ray optical system comprising:
a waveguide that includes a core and a cladding and that guides X-rays from an X-ray source; and
an optical element that condenses the X-rays from the waveguide,
wherein the core has a periodic structure,
a critical angle for total internal reflection of the X-rays at an interface between the core and the cladding is larger than a Bragg angle of the periodic structure, and
the optical element condenses the X-rays from the waveguide at least in a direction parallel to the interface between the core and the cladding.

2. The X-ray optical system according to claim 1,
wherein the core has the periodic structure in which a plurality of portions having refractive indices with different real parts are arranged periodically, and
the Bragg angle of the periodic structure is larger than a critical angle for total internal reflection of the X-rays at an interface between the plurality of portions.

3. The X-ray optical system according to claim 1,
wherein the periodic structure of the core has a one-dimensional periodic structure in which a plurality of substances are stacked periodically.

4. The X-ray optical system according to claim 1,
wherein the optical element includes at least one of a Fresnel zone plate, a total-reflection mirror, a multilayer film mirror, and a waveguide.

5. The X-ray optical system according to claim 1,
wherein the optical element condenses the X-rays from the waveguide only in the direction parallel to the interface between the core and the cladding.

6. The X-ray optical system according to claim 1,
wherein the optical element condenses the X-rays from the waveguide at least in a direction that is parallel to the interface between the core and the cladding and that is perpendicular to a direction of emission of the X-rays from the waveguide.

7. The X-ray optical system according to claim 1,
wherein the core is a mesostructure.

8. The X-ray optical system according to claim 7,
wherein the core is made of a mesoporous silica film.

9. The X-ray optical system according to claim 2,
wherein the plurality of portions include a silica portion and a hole portion of a mesoporous silica film.
